(19) United States
(12) Patent Application Publication
(10) Pub. No.: US 2025/0208078 A1
(43) Pub. Date: Jun. 26, 2025

(54) MONITORING SYSTEMS AND MONITORING METHODS FOR PNEUMATICALLY ACTUATED DOOR

(71) Applicant: Nanyang Technological University, Singapore (SG)

(72) Inventors: Srikanth NARASIMALU, Singapore (SG); Alok Kumar VERMA, Singapore (SG); Santhanakrishnan Mahesh RAMANATHAN, Singapore (SG)

(21) Appl. No.: 18/848,505

(22) PCT Filed: Mar. 24, 2023
(86) PCT No.: PCT/SG2023/050198

§ 371 Date: Sep. 18, 2024

(30) Foreign Application Priority Data
Mar. 25, 2022 (SG) 10202203108P

(51) Int. Cl. G01N 25/66; E05F 15/71

(52) U.S. Cl. CPC G01N 25/66; E05F 15/71; E05Y 2900/506

(57) ABSTRACT

Systems and methods for monitoring a pneumatically actuated door are described. A monitoring system for a pneumatically operated door, comprises: a dew point sensor configured to monitor a moisture level of an interior of a cylinder of a pneumatic actuator of the pneumatically operated door; and a controller coupled to the dew point sensor and configured to compare the moisture level of the interior of the cylinder of the pneumatic actuator of the pneumatically operated door with a threshold and to generate an alert if the moisture level exceeds the threshold.

### TECHNICAL FIELD

The present disclosure relates to monitoring pneumatically actuated doors such as doors of passenger vehicles.

### BACKGROUND

Transport systems are required to operate with a high level of safety and reliability. Specially, the door system is one of the major factors influencing the safety of the vehicle. Presently, most of the bus doors are operated by compressed air. However, such a system is prone to fail due to various reasons. The most common bus door failure happens due to the pneumatic system malfunction to operate due to moisture in the system. This moisture can be monitored and controlled using sensors suit to understand the moisture content in the compressed air. On the other side, the mechanical issues like linkage adjustment can be monitored and controlled by adding sensor.

Much of the current research into door operation and failure is focused on the drive mechanism and control of the vehicle doors. Most of the door monitoring products available in the market are only able to deals with door operation mechanism and control.

### SUMMARY

According to a first aspect of the present disclosure, a monitoring system for a pneumatically operated door is provided. The monitoring system comprises: a dew point sensor configured to monitor a moisture level of an interior of a cylinder of a pneumatic actuator of the pneumatically operated door; and a controller coupled to the dew point sensor and configured to compare the moisture level of the interior of the cylinder of the pneumatic actuator of the pneumatically operated door with a threshold and to generate an alert if the moisture level exceeds the threshold.

In an embodiment, the threshold is a dew point of at least 12° C. In an embodiment, the threshold is a dew point of at least 15° C. In an embodiment, the threshold is a moisture content of at least 12,000 parts per million by volume. In an embodiment, the threshold is a moisture content of at least 12,000 parts per million by volume.

According to a second aspect of the present disclosure, a method of monitoring a pneumatically operated door is provided. The method comprises: receiving an indication of a moisture level of an interior of a cylinder of a pneumatic actuator of the pneumatically operated door; comparing the moisture level of the interior of the cylinder of the pneumatic actuator of the pneumatically operated door with a threshold; and generating an alert if the moisture level exceeds the threshold.

In an embodiment, the threshold is a dew point of at least 12° C. In an embodiment, the threshold is a dew point of at least 15° C. In an embodiment, the threshold is a moisture content of at least 12,000 parts per million by volume. In an embodiment, the threshold is a moisture content of at least 12,000 parts per million by volume.

According to a third aspect of the present disclosure, a computer readable medium carrying processor executable instructions which when executed on a processor cause the processor to carry out a method described above is provided.

### BRIEF DESCRIPTION OF THE DRAWINGS

In the following, embodiments of the present invention will be described as non-limiting examples with reference to the accompanying drawings in which:

FIG. 1 is a block diagram showing a pneumatically actuated door monitoring system according to an embodiment of the present invention;

FIG. 2 is a block diagram showing a controller of a pneumatically actuated door monitoring system according to an embodiment of the present invention;

FIG. 3 is shows a pneumatically actuated door system;

FIG. 4 is a flowchart showing a pneumatically actuated door monitoring method according to an embodiment of the present invention;

FIG. 5 is a flowchart showing a pneumatically actuated door monitoring method according to an embodiment of the present invention;

FIG. 6 is a flowchart showing a pneumatically actuated door monitoring method according to an embodiment of the present invention;

FIG. 7A to FIG. 7C show analysis of accelerometer time domain waveforms;

FIG. 8A to FIG. 8C show frequency analysis of the time domain waveforms shown in FIG. 7A to FIG. 7C;

FIG. 9A shows the output of a proximity sensor over time with no operation of the door and FIG. 9B shows a frequency analysis of the output of the proximity sensor;

FIG. 10A shows the output of a proximity sensor over time when the door is under operation door and FIG. 10B shows a frequency analysis of the output of the proximity sensor; and

FIG. 11A and FIG. 11B are graphs showing moisture content and dew point sensor output against number of door operations.

### DETAILED DESCRIPTION

The present disclosure provides door monitoring systems with door failure/jam detection due to the various reasons specially, using moisture contents from compressed air are captured and validated. Previously, door fault of the transport system was detected using different signals such as acceleration, velocity, Force, pressure, and displacement. The main contribution of this work is to detect changes through functional signature of dew point sensor i.e., moisture content which is a major responsible for the door failure. Every observation is a signature representing moisture content of the compressed air coming from actuator during an opening or closing cycle of a door. Such signatures can be accurately represented by specific signal or statistical analysis using dew point/ppm data. Additionally, signals from accelerometer, force sensor, proximity sensor, temperature sensor, angular position sensor is used to validate the door jam/failure by analyzing the signals. The system provides a using low cost, single controller apparatus interfaced with different smart sensors and develop a suitable analysis method using signal processing and machine learning techniques to predict the failure at an early stage.

General passenger transport systems are now available with air conditioning. These air conditioning systems conflict with pneumatic system of the door and it is difficult to differentiate the environmental condition of the air conditioning and pneumatic system.

Therefore, some embodiments are concerned with developing a real-time IoT based efficient smart door monitoring system for a public vehicle e.g., transport bus.

Thus, the systems and methods of the present disclosure provide for monitoring real-time door operation and prediction of door failure/jam at an early stage using an onboard IoT based processor with inbuilt data analytics methods. Therefore, provided system will help and ease the task of technician using local and remotely placed operational advisory dashboard. Further, the operator/technician will get information about health condition of the door. Therefore, information presented using the dashboard will be able to improve the safety of passengers.

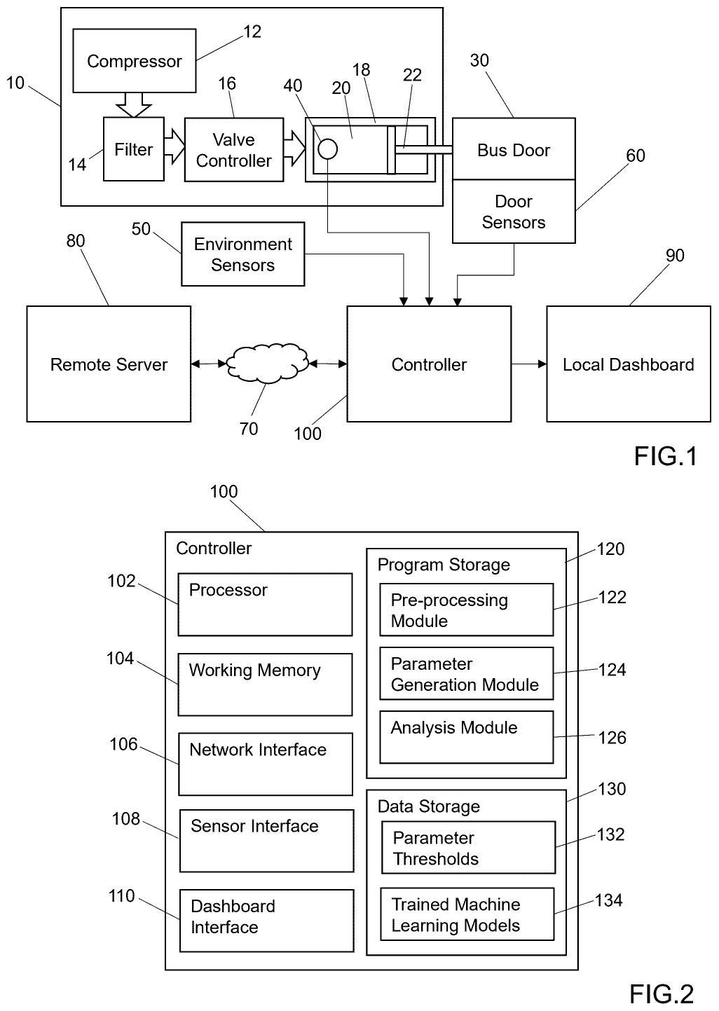

FIG. 1 is a block diagram showing a pneumatically actuated door monitoring system according to an embodiment of the present invention. As shown in FIG. 1, the system monitors the operation of an actuation system 10 which controls a bus door 30. The actuation system 10 comprises a compressor 12 which is coupled to a filter 14. Compressed air from the filter 14 enters a valve controller 16 which controls flow of compressed air into a cylinder 20 of an actuator 18. Compressed air in the cylinder 20 causes a piston 22 arranged in the cylinder 20 to move and thereby open or close a bus door 30. The bus door 30 is formed as bi-fold door.

The pneumatically actuated door monitoring system comprises a dew sensor 40 arranged within the cylinder 20 of the actuator 18. The pneumatically actuated door monitoring system further comprises environment sensors 50 and door sensors 60. The system includes combination of smart sensors which helps to predict door jam, distance of passengers from door for their safety and environmental conditions. door sensors 60 may include an accelerometer used as energy sensor, a force sensor to detect door jam/jerk includes strain gauge module, a proximity sensor used to detect any blockage on the door, passenger safety and to locate the passenger distance from the door. The door sensors 60 may also include a current sensor to check the condition of the door operator (motor/compressor pump), and angular position sensors to check the arm position of the door. The environment sensors 50 may include smoke detectors, temperature sensors, humidity sensor and dew point sensors. The environment sensors 50 may be located within the bus or to outside the bus to monitor exterior conditions or both within and outside the bus.

A controller 100 is configured to monitor the door actuation system. The controller 100 is coupled to the dew point sensor 40, the environment sensors 50 and the door sensors 60. The controller 100 is coupled to a remote server 80 by a wireless network 70, and to a local dashboard 90. The remote server 80 may be implemented as a cloud platform to perform analysis of the operation of the door actuation system using the extracted features. The local dashboard 90 generates alerts, for example to indicate that a fault has occurred in the door actuation system based on the analysis of the extracted features carried out by the controller 100. A service technician may provide preventive maintenance based upon the identified and predicted signatures for operating conditions of the door actuation system.

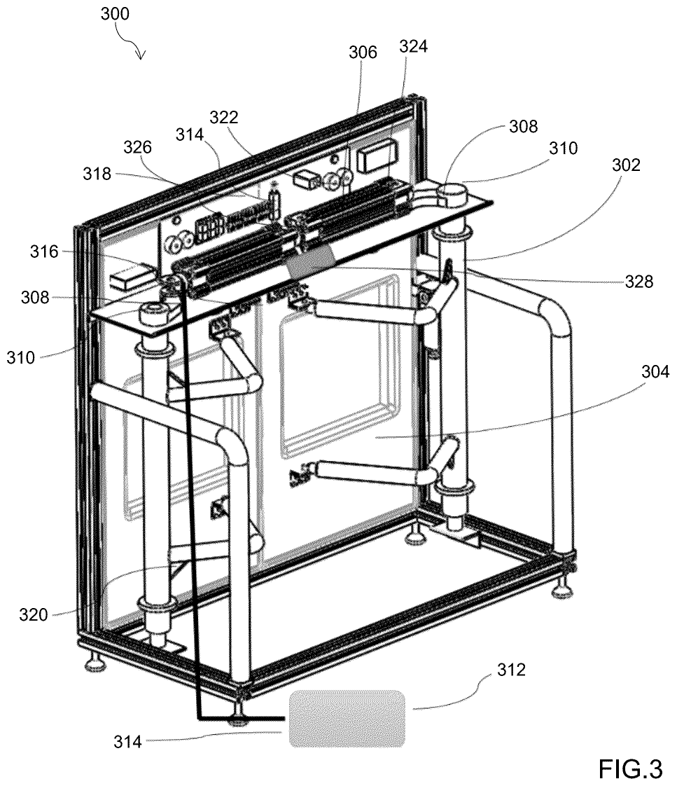

FIG. 2 is a block diagram showing a controller of pneumatically actuated door monitoring system according to an embodiment of the present invention. The controller 100 may be implemented as a system-on-module or a single board computer. As shown in FIG. 2, the controller 100 comprises a processor 102, a working memory 104, a network interface 106, a sensor interface 108, a dashboard interface 110, program storage 120 and data storage 130.

The processor 102 may be implemented as one or more central processing unit (CPU) chips such as a cortex-A72 processor. The program storage 120 is a non-volatile storage device such as a solid state memory which stores computer program modules. The computer program modules are loaded into the working memory 104 for execution by the processor 102. The network interface 106 is an interface that allows the controller 100 to communicate with other devices and systems, the remote server 80. The sensor interface 108 is an interface which allows the data captured by the dew point sensor 40, the environment sensors 50 and the door sensors 60 to be received and processed by the controller 100. The dashboard interface 110 is configured to allow the controller to generate indications and/or alerts for a user such as a technician or driver of the vehicle via the local dashboard 90. The sensor interface 108 may be implemented as a serial peripheral interface (SPI), Inter-Integrated Circuit (i2c) interface, serial communication interface or Modbus protocol interface.

The program storage 120 stores a pre-processing module 122, a parameter generation module 122, and an analysis module 124. The computer program modules cause the processor 102 to execute various pneumatically actuated door monitoring methods described in more detail below. The program storage 120 may be referred to in some contexts as computer-readable storage media and/or non-transitory computer-readable media. As depicted in FIG. 2, the computer program modules are distinct modules which perform respective functions implemented by the controller 100. It will be appreciated that the boundaries between these modules are exemplary only, and alternative embodiments may merge modules or impose an alternative decomposition of the functionality of modules. For example, the modules discussed herein may be decomposed into sub- modules to be executed as multiple computer processes and, optionally, on multiple computers. Moreover, alternative embodiments may combine multiple instances of a particular module or sub-module. It will also be appreciated that, while a software implementation of the computer program modules is described herein, these may alternatively be implemented as one or more hardware modules (such as field-programmable gate array(s) or application-specific integrated circuit(s)) comprising circuitry which implements equivalent functionality to that implemented in software.

The data storage 130 stores parameter thresholds 132 and trained machine learning models 134. The parameter thresholds 132 and the trained machine learning models 134 are used by the analysis module 126 to analyze parameters of the sensed signals to determine information on the condition of the pneumatically actuated door. The parameter thresholds 132 may be determined by the remote server 80 and sent to the controller 100 via the network interface 106. Similarly, the trained machine learning modules may be trained on the remote server 80 and sent to the controller 100 via the network interface 106.

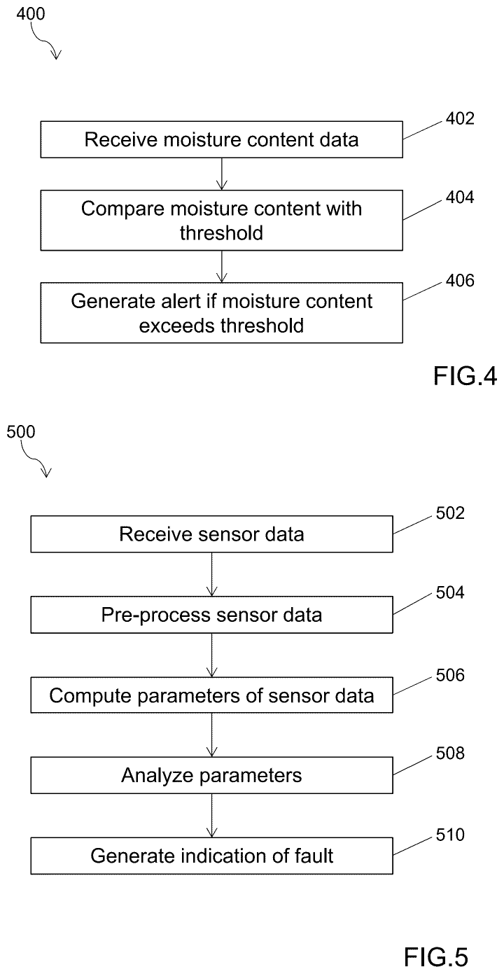

FIG. 3 is shows a pneumatically actuated door system. The pneumatically actuated door system 300 comprises a door frame 302, and doors 304. A pair of actuators 306 is located at the top of the doors 304 and each actuator 306 of the pair is coupled to one of the doors 304. Force sensors 308 are located on the connection between the actuators 306 and the doors 304 to measure the force applied by the actuators 306 to open and close the doors 304. Accelerometers 310 are coupled to the doors 304 to measure the acceleration of the doors 304. The actuators 306 are coupled to an air compressor which is powered by a motor 312. A current sensor 314 arranged to measure the current supplied to the motor 312.

Proximity sensors 316 are arranged above the doors 304 to detect the presence of passengers close to the doors 304. A dew point sensor 318 is arranged in the cylinder of the actuators 306. An angular position sensor 320 is coupled to each of the doors 302 to measure the angular position of each door 304. A smoke detector 322 is located above the doors 304. A humidity sensor is located outside the doors 304 to measure environmental humidity. Temperature sensors 324 are located on the cylinder of the actuators 306 to measure the cylinder temperature and outside the doors 304 to measure environmental temperature. A programmable logic controller 326 controls operation of the doors 304. A current sensor 314 is connected in series with the programmable logic controller 326. A door monitoring system controller 328 is located above the doors 304 and coupled to the various sensors. The door monitoring system controller 328 may be implemented as the controller 100 shown in FIG. 2.

The most common bus door failure happens due to the pneumatic system malfunction to operate due to moisture in the system. This moisture can be monitored and controlled using sensors suit to understand the moisture content in the compressed air. Based on this, the pneumatically actuated door monitoring system includes a dew point sensor among the sensors. Therefore, bus door failure due to moisture contents from the compressed air is considered as key failure modes. The moisture content using the dew point and PPMV (parts per million by volume) parameters were captured and validated using dew point sensor. The comparison of results using dew point sensors along with other smart sensors are used to validate the failure modes with the smart monitoring of door operation, which is useful for passenger's safety with high accuracy level.

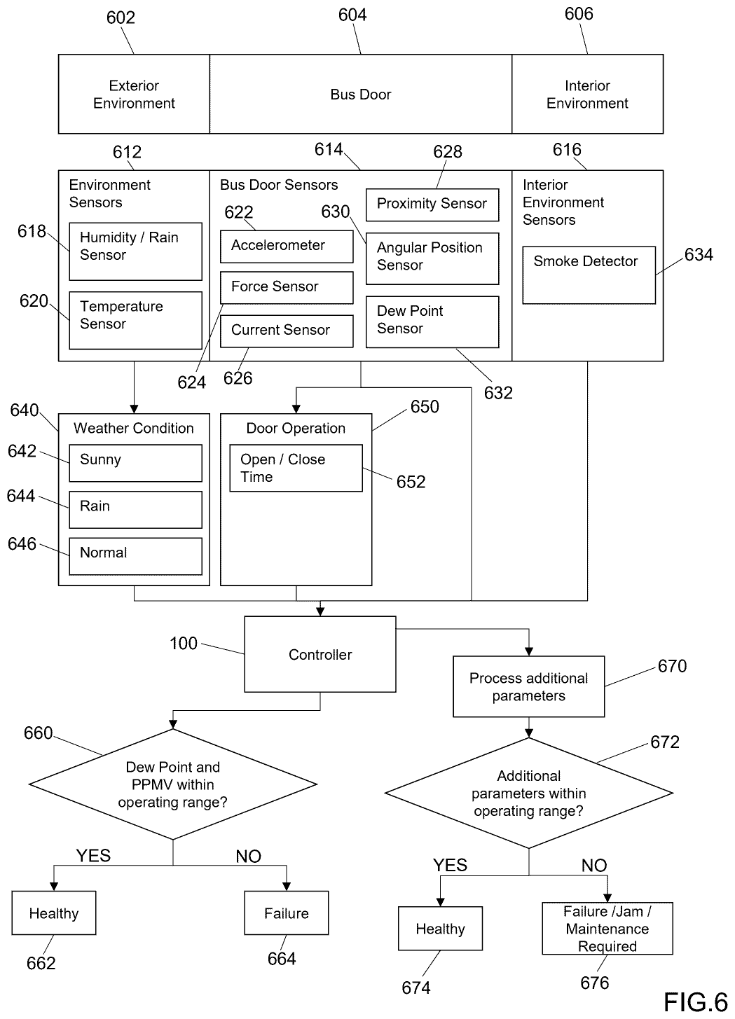

FIG. 4 is a flowchart showing a pneumatically actuated door monitoring method according to an embodiment of the present invention. The method 400 shown in FIG. 4 is carried out by the controller 100 shown in FIG. 2.

In step 402, the sensor interface 108 of the controller 100 receives moisture content data from the dew point sensor 40 located within the cylinder 20 of the actuator 18.

In step 404, the analysis module 126 is executed on the processor 102 of the controller 100 to compare the moisture content with a threshold. The threshold may be looked up from the parameter thresholds 132 stored in the data storage 130 of the controller 100. As described in more detail below, the threshold may be a dew point between 12° C. and 15° C., or a PPMV moisture content of between 12000 and 15000.

In step 406, an alert is generated if the moisture content exceeds the threshold. The alert may be generated by the dashboard interface 110 sending an alert message to the local dashboard 90 for display to an operator such as the driver of the bus.

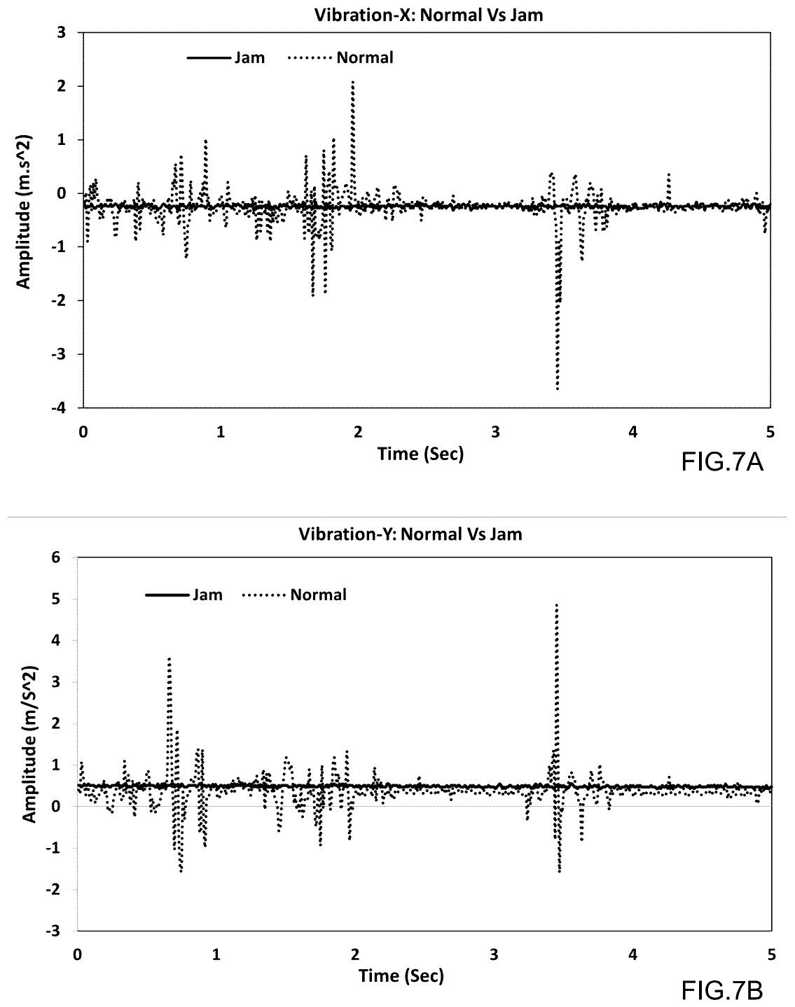

FIG. 5 is a flowchart showing a pneumatically actuated door monitoring method according to an embodiment of the present invention. The method 500 shown in FIG. 5 is carried out by the controller 100 shown in FIG. 2.

In step 502, the controller 100 receives sensor data from the sensors (the dew point sensor 40, the environment sensors 50 and the door sensors 60). The sensor data may be received and processed in real-time or near real-time.

In step 504, the pre-processing module 122 is executed by the processor 102 to pre-process the sensor data. The pre-processing may comprise filtering the received signals to remove noise. The received signals may be influenced by noise such as powerline noise and mechanical noise. The noise can be removed by filtering, for example, a notch filter may be used to remove powerline noise.

In step 506, the parameter generation module 134 is executed by the processor 102 to compute parameters of the sensor data. The computation of parameters of the current data comprises extracting features from the sensor data. The signals can be signals can be analyzed in time domain, frequency domain analysis, entropy analysis, envelop analysis and time-frequency domain analysis approach by using data analytics/signal processing techniques. Time-domain and frequency domain analysis is mostly used here for feature extraction. Different time domain, entropy, envelop and frequency domain analysis features which can be extracted from sensor data includes: (1) RMS value, (2) Peak value, (3) Crest factor, (4) Variance, (5) Skewness and (6) Kurtosis, (7) entropy, (8) spectrum analysis, (9) envelop using Hilbert transform and (10) wavelet transform based analysis.

The frequency domain analysis methods are based on the Fast Fourier transform and sometimes can be used as full spectrum. The guiding principle of frequency analysis of the signal is that the frequency spectrum of the signal has frequency components which can be directly related to the change of data. Any change in the data results in the change of these frequency components. So, this is another method used for parameter calculation.

In step 308, the analysis module 126 is executed by the processor 102 to analyze the extracted parameters. After processing the input and extracting the features from sensor signals, the parameters are used to identify and predict faults or jams in the pneumatically actuated door. In some embodiments, the analysis is carried out using a trained machine learning model 134 such as an artificial neural network, a support vector machine or a fuzzy logic to classify the condition of the alternator based on the extracted features. In other embodiments, the analysis is carried out by comparing features with stored parameter thresholds 132.

In step 310, the controller 100 generates an indication of a fault if the analysis in step 308 indicates that there is a fault. The indication of the fault may be generated as an alert to a user, for example by providing an indication on the local dashboard 90.

The calculated parameters may be sent to the remote server 80 for storage, display, and control from a remote location-based control station in addition to providing an alert to the user on the local dashboard 90. The remote server 80 may use the received parameters in further train machine learning models or to recalculate and calibrate parameter thresholds.

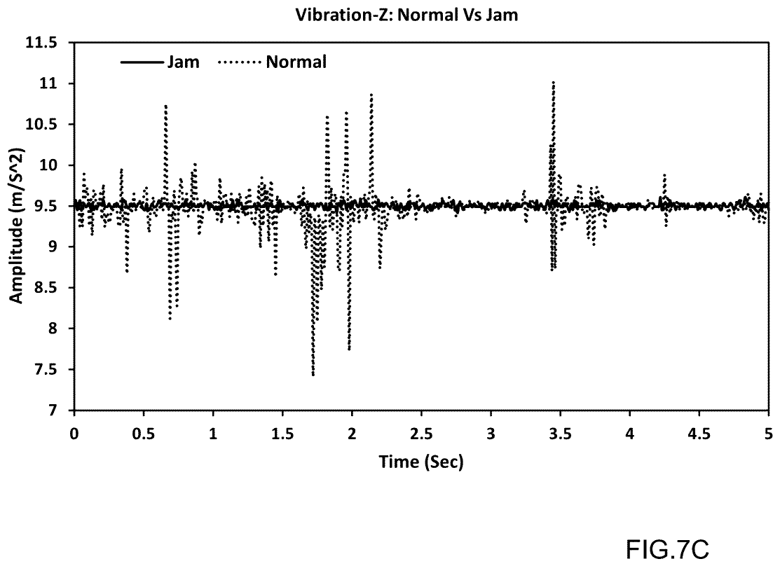

FIG. 6 is a flowchart showing a pneumatically actuated door monitoring method according to an embodiment of the present invention.

As shown in FIG. 6, sensors are arranged to monitor three general locations: the exterior environment 602 of the bus, the bus door 604, and the interior environment 606 of the bus. Environmental sensors 612 comprising rain or humidity sensors 618 and a temperature sensor 620 are arranged to monitor the exterior environment 602. Bus door sensors 614 comprising an accelerometer 622, a force sensor 624, a current sensor 626, a proximity sensor 628, an angular position sensor 630 and a dew point sensor 632 are arranged to monitor the bus door 604. The bus door sensors 614 may be arranged as described above with reference to FIG. 3. Interior environment sensors 616 comprising a smoke detector 634 are arranged to monitor the interior environment of the bus.

As described above, the output from the dew point sensor 632 may be used alone to identify faults or generate alerts for the pneumatically actuated door of the bus, in some embodiments, additional sensor data is used. The addition of other sensor data helps enhance the certainty of sensor detection of moisture in the compressed air to foresee the condensation issues. This is done based on the Bayesian way of data fusion to enhance the probability of detection. This helps to detect sensor health and alert the system if it is malfunction.

As shown in FIG. 6, the data from the environment sensors 612 is used to determine the current weather condition 640. The weather condition 640 may be one of sunny 642, rain 644 and normal 646. In some embodiments, the time for which the bus (and therefore the bus door) are operational in each type of weather condition may be recorded. Further, as shown in FIG. 6, the door operation 650 of the bus door 640 may be monitored and recorded. This may include recording the open/close time 652 of the door.

The controller 100 processes the sensor data and the weather condition 640 and door operation 650 data. Based on this processing, the operation of the door may be classified as healthy or failure and alerts may be generated for maintenance of the bus door.

The processing by the controller 100 may comprise a step 660 of determining if the dew point and PPMV are within the normal operating range. The normal operating range may be a dew point in the range of 12° to −6.6° C. and/or a PPMV in the range 12,500 to 30,000. If the dew point and the PPMV are within this normal operating range, the door actuation system may be indicated as healthy in step 662. If the dew point and PPMV are outside this normal operation range then the door actuation system is indicated to be as failure in step 664. It will be appreciated that different ranges for the dew point and PPMV may be used, and in some embodiments, the dew point and/or PPMV may be compared with a threshold rather than a normal operating range. Further, one or both of the dew point and PPMV may be used to identify whether the actuation system is healthy.

In some embodiments, additional parameters may be used in combination with the dew point sensor data to identify possible failures of the door actuation system. As shown in FIG. 6, in step 670 additional parameters such as the sensor data or weather condition 640 and door operation 650 are processed. In step 672 the additional parameters are compared with an operating range. If the additional parameters are within the operating range, then the door actuation system is indicated to be healthy in step 674. If the additional parameters are outside the operating range, then in step an indication that the door actuation system has failed, jammed or requires maintenance is generated.

For example, the weather condition data may used to identify the occurrence of rain and the condensation chances. The external temperature & humidity of external and the internal are used in the calculation of the dew point data. The data is used in a surrogate model as per thermodynamics based surrogate model. Further the actual sensor signal data and surrogate model are used in deep learning system.

In the following, data analysis techniques used by the analysis module 126 will be described. The method includes calculation of specific parameters using data analytics techniques by the processor. Data analytics techniques include time domain and frequency domain-based signal analysis and parameters calculation.

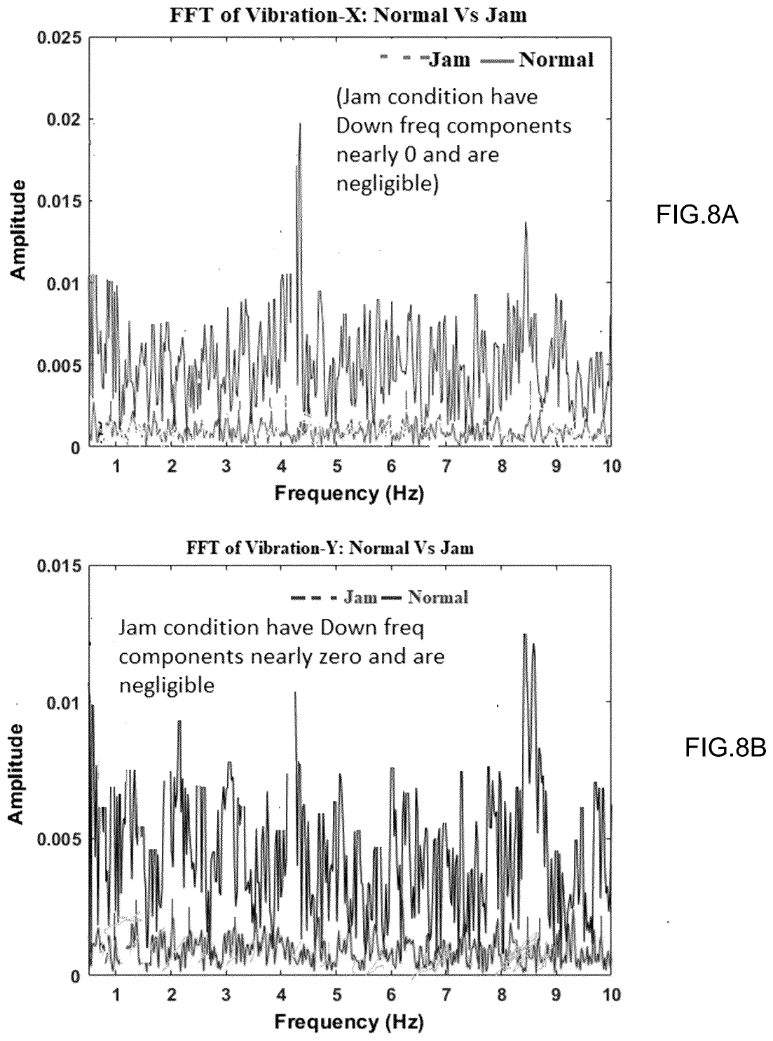

FIG. 7A to FIG. 7C show analysis of accelerometer time domain waveforms.

FIG. 7A shows a raw vibration signal in the x-direction obtained from a tri-axial accelerometer for both a normal and jam conditions. FIG. 7B shows a raw vibration signal in the y-direction obtained from a tri-axial accelerometer for both a normal and jam conditions. FIG. 7C shows a raw vibration signal in the z-direction obtained from a tri-axial accelerometer for both a normal and jam conditions.

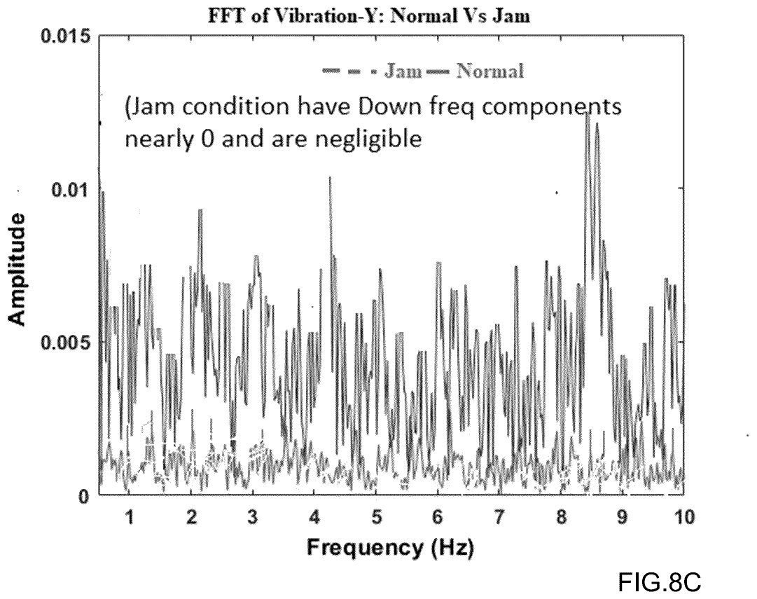

FIG. 8A to FIG. 8C show frequency analysis of the time domain waveforms shown in FIG. 7A to FIG. 7C.

The frequency domain signals are obtained using a fast Fourier transform (FFT). In FIG. 8A to FIG. 8C, the arrows represent the peak harmonics which shows normal door operation and can be used to differentiate between normal and jam condition with for alarm level.

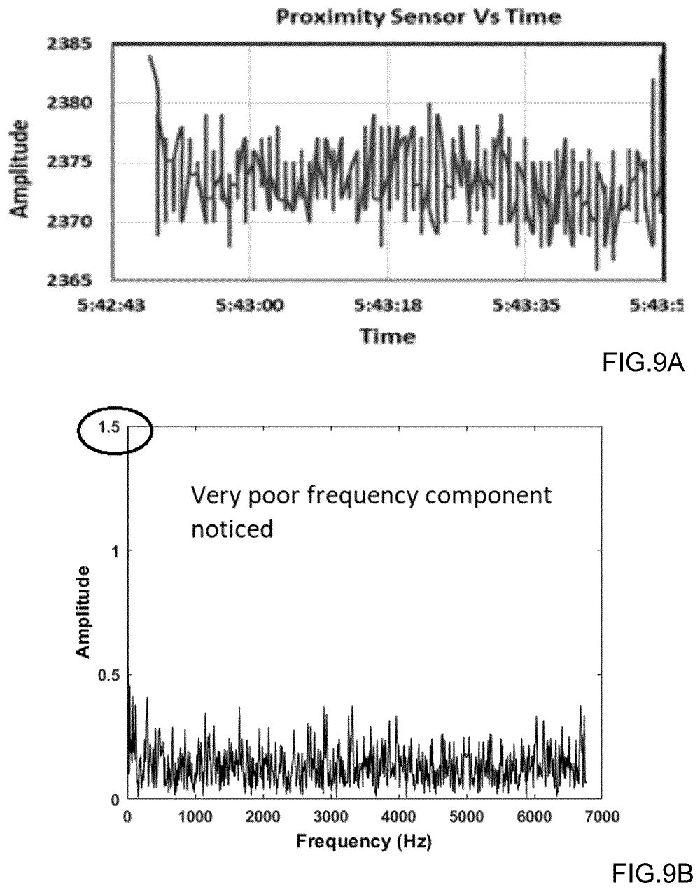

FIG. 9A shows the output of a proximity sensor over time with no operation of the door and FIG. 9B shows a frequency analysis of the output of the proximity sensor.

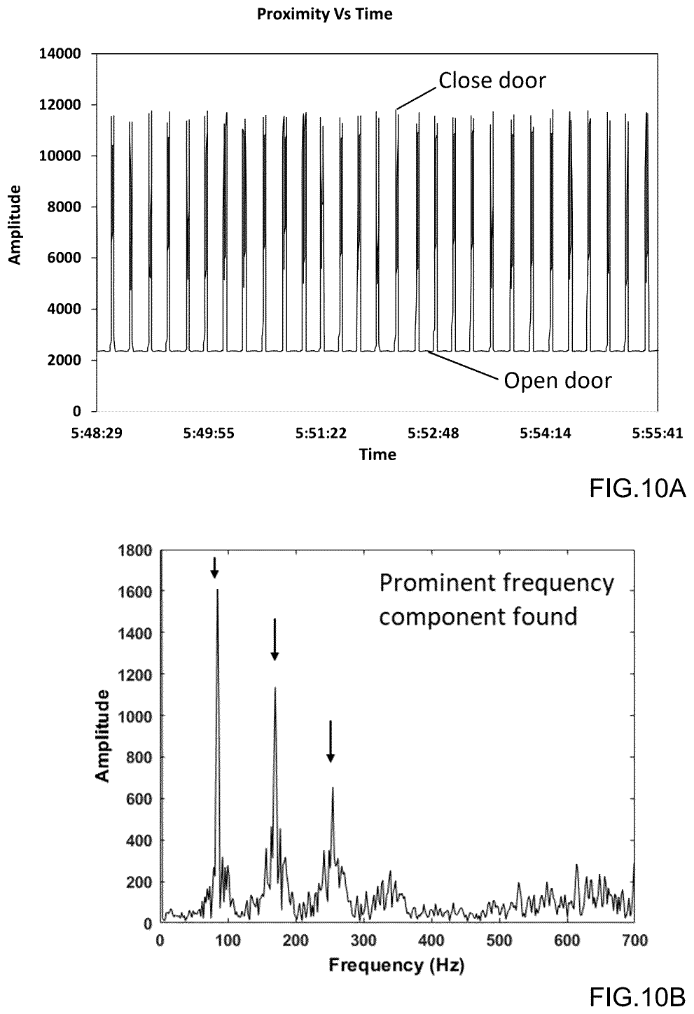

FIG. 10A shows the output of a proximity sensor over time when the door is under operation door and FIG. 10B shows a frequency analysis of the output of the proximity sensor.

As shown in FIG. 10B, when the door is under operation, prominent frequency components are found. When the door is not operated, the frequency components are very low as shown in FIG. 9B.

The arrow marks in FIG. 10B indicate the peak harmonics which indicate that the door is operating normally and properly opened or properly closed.

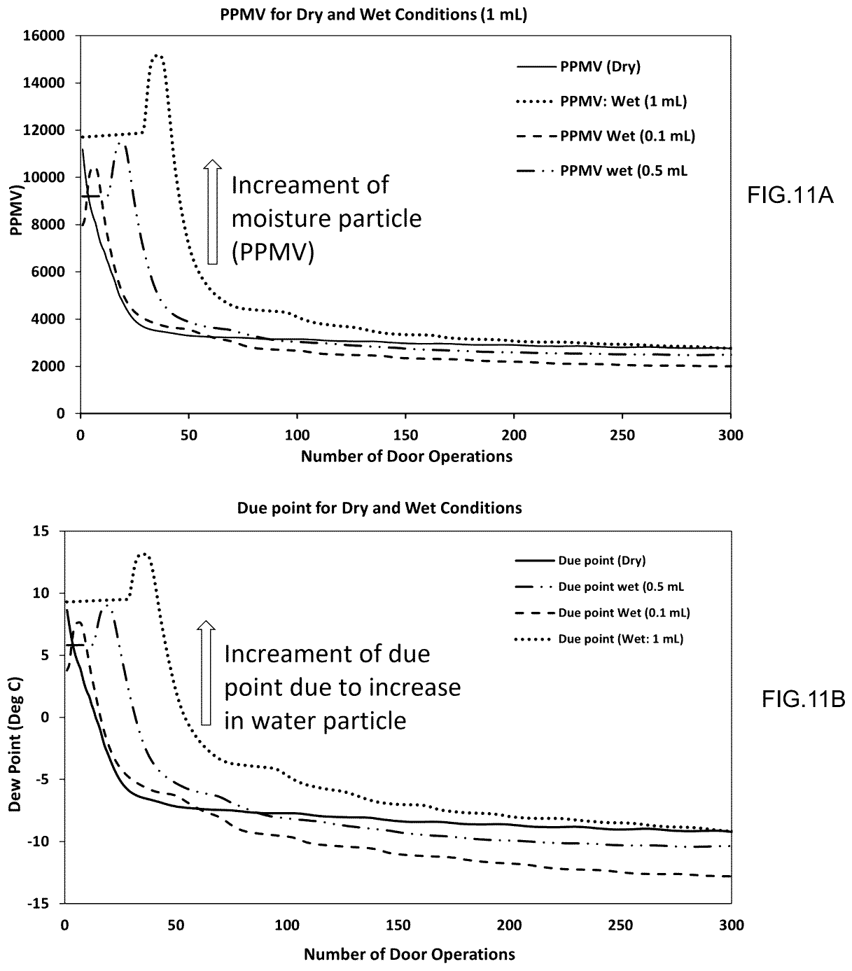

FIG. 11A and FIG. 11B are graphs showing moisture content and dew point sensor output against number of door operations.

An experiment was conducted by creating wet or dry conditions inside an actuator and then operating the actuator a number of times and monitoring the change in due point and number of moisture particles (parts per million volume—PPMV). Experiment with dry condition have optimal condition when compared with the wet condition and also can be observed that the wet condition along with 1 ml of water drop after the filter has greatly influenced the door system. The shown experiments were conducted with every door operation at 5.85 Sec.

It was also noticed that whenever amount of water drops increases in the compressed air, dew point/PPMV increases. This increment in the moisture amount affects the seal of the cylinder situated at the door system causes swelling of the seal and due to this swelling, frictional force in the cylinder increased and finally, that leads to the condition of door jam. Also, to be observed that when the moisture content reaches near to 12000-15000 for PPMV and 12-15° C. dew point, the door started getting jam. So, the threshold for alarm has been set to the 15° C. in case of dew point and 15000 for PPMV. Similarly, we can set alarm for the other sensors discussed above. For example, in the case of accelerometer sensor, we can select the harmonic peaks of the sensor to predict normal condition. If the harmonic peaks reduce at certain level, we may understand that the door have the problem and getting jam. It was concluded that the operational time of the door and environmental conditions may affect the dew point and PPMV measurement at certain level.

Whilst the foregoing description has described exemplary embodiments, it will be understood by those skilled in the art that many variations of the embodiments can be made within the scope and spirit of the present invention.

1. A monitoring system for a pneumatically operated door, the monitoring system comprising:
a dew point sensor configured to monitor a moisture level of an interior of a cylinder of a pneumatic actuator of the pneumatically operated door; and
a controller coupled to the dew point sensor and configured to compare the moisture level of the interior of the cylinder of the pneumatic actuator of the pneumatically operated door with a threshold and to generate an alert if the moisture level exceeds the threshold.

2. The monitoring system according to claim 1, wherein the threshold is a dew point of at least 12° C.

3. The monitoring system according to claim 2, wherein the threshold is a dew point of at least 15° C.

4. The monitoring system according to claim 1, wherein the threshold is a moisture content of at least 12,000 parts per million by volume.

5. The monitoring system according to claim 4, wherein the threshold is a moisture content of at least 15,000 parts per million by volume.

6. A method of monitoring a pneumatically operated door, the method comprising:
receiving an indication of a moisture level of an interior of a cylinder of a pneumatic actuator of the pneumatically operated door;
comparing the moisture level of the interior of the cylinder of the pneumatic actuator of the pneumatically operated door with a threshold; and
generating an alert if the moisture level exceeds the threshold.

7. The method according to claim 6, wherein the threshold is a dew point of at least 12° C.

8. The method according to claim 7, wherein the threshold is a dew point of at least 15° C.

9. The method according to claim 6, wherein the threshold is a moisture content of at least 12,000 parts per million by volume.

10. The method according to claim 9,
wherein the threshold is a moisture content of at least 15,000 parts per million by volume.

11. A computer readable medium carrying processor executable instructions which when executed on a processor cause the processor to carry out a method according to claim 6.
